(19) United States
(12) Patent Application Publication
(10) Pub. No.: US 2025/0369845 A1
(43) Pub. Date: Dec. 4, 2025

(54) SYSTEMS AND METHODS FOR TESTING A RUPTURE DISC

(71) Applicant: Emerson Automation Solutions Final Control UK Ltd, Manchester (GB)

(72) Inventors: Stephen Gray, Manchester (GB); Alexander Timms, Manchester (GB)

(21) Appl. No.: 19/209,502

(22) Filed: May 15, 2025

(30) Foreign Application Priority Data
May 28, 2024 (GB) 2407547.5

(51) Int. Cl. G01N 3/12; G01M 13/003; G01N 3/06

(52) U.S. Cl. CPC G01N 3/12; G01M 13/003; G01N 3/066; G01N 2203/0067

(57) ABSTRACT

A test assembly for a rupture disc includes a disc holder and a clamp arranged to hold the rupture disc and constrain the rupture disc in an axial direction. A heater assembly can be in thermal communication with the disc holder to heat the rupture disc and pressurized gas supplied under the dome of the rupture disc. The heater assembly can rapidly heat the rupture disc to a set temperature and the test assembly and provide pressurized gas under the dome to determine and record a bursting pressure at the set temperature. The heater assembly can include a heater body and heating elements that project into a central opening of the heater body.

### BACKGROUND

Fluid systems, including pipelines and vessels, can store, transport, or otherwise dispense fluids, including pressurized gases and liquids. Often these systems employ safety devices that can protect the system from over pressurization. One example safety device is a rupture disc, also known as a pressure safety disc, burst disc, or burst diaphragm. Rupture discs typically require particular testing and inspection to ensure compliance with applicable standards.

### SUMMARY

Some examples of the present disclosure provide a test assembly for a rupture disc. The test assembly can include a disc holder, a clamp member, and a heating assembly. The disc holder can be arranged to hold the rupture disc and the clamp member can be arranged opposite the rupture disc from the disc holder to clamp the rupture disc between the disc holder and the clamp member to constrain the rupture disc in an axial direction. The heater assembly can be in thermal communication with the disc holder. The heater assembly can include a heater body having an opening and at least one hole, the opening being axially aligned with the disc holder so as to be axially aligned with the rupture disc as clamped between the disc holder and the clamp member, and the at least one hole can extend through the heater and intersect the opening.

In some examples, a test assembly for a rupture disc can include at least one heating element that is threadedly received by at least one hole of a heater body of a heater assembly of the test assembly.

In some examples, a test assembly for a rupture disc can include at least one heating element. The at least one heating element is a glow plug.

In some examples, a test assembly for a rupture disc can include a heater assembly having a heater body. The heater body can include an annular ring with an opening that is a central opening of the annular ring. At least one hole of the heater body can extend radially through the annular ring to intersect the central opening.

In some examples, a test assembly for a rupture disc can include a heater assembly having a heater body. The heater body can include a circumferential groove that receives one or more wires that power at least one heating element of the heater assembly.

In some examples, a test assembly for a rupture disc can include a heater assembly having a heater body. The heater body can include a plurality of holes and a plurality of heating elements that extend through a respective one of the plurality of holes. Each heating element of the plurality of heating elements can extend into an opening (e.g., a central opening) of the heater body.

In some examples, a test assembly for a rupture disc can include a first heater assembly and a second heater assembly. The first and second heater assemblies can be arranged in series to heat the rupture disc.

In some examples, a test assembly for a rupture disc can include a thermometer and an electric control device. The thermometer can be arranged to output signals indicating temperature at the rupture disc during a test and the electronic control device can be configured to control pressurization of gas against the rupture disc based on signals from the thermometer or other feedback device.

In some examples, a test assembly for a rupture disc can include a thermometer that includes a thermocouple assembly that is disposed, in an axial direction, between a disc holder and a heater assembly

In some examples, a test assembly for a rupture disc can include a gasket that is disposed, in an axial direction, between a heater assembly and a thermocouple assembly, to provide a gas seal between the heater assembly and the thermocouple assembly.

In some examples, a test assembly for a rupture disc can include an arrangement of at least one heating element within a heater assembly that is configured to heat the rupture disc to a set temperature between 100 degrees Celsius and 400 degrees Celsius, inclusive, in less than 5 minutes.

Some examples of the present disclosure provide a test assembly for rupture discs. The test assembly can include a heater body and at least one heating element. The heater body can have a central opening configured to be axially aligned with a rupture disc being tested so that pressurized gas within the central opening is in communication with the rupture disc. The at least one heating element can extend into the central opening and can be supported by the heater body so that the at least one heating element is spaced axially apart from the rupture dis to heat the rupture disc via convection of the pressurized gas.

In some examples, a test assembly for rupture discs can include an electronic controller. The electronic controller can be configured to receive a temperature signal from a thermocouple in thermal communication with a pressurized gas and to control heat supplied by at least one heating element based on the temperature signal and a test-procedure set temperature.

In some examples, a test assembly for rupture discs can include a heater with a heater body. The heater body can include a circumferential groove that receives one or more wires to connect a controller and at least one heating element.

In some examples, a test assembly for rupture discs can include a heater assembly with a central opening. A heater body can surround the central opening. At least one heating element can be secured relative to the heater body via a threaded connection with a corresponding hole that extends through the heater body and intersects the central opening.

In some examples, a test assembly for rupture discs can include a heater assembly having a heater body. The heater body can include an annular ring that defines a planar top surface that is axially spaced from a bottom surface.

In some examples, a test assembly for rupture discs can include a heater assembly with a heater body. The heater body can be an integrally formed, unitary body.

Some examples of the present disclosure provide a method of using a test assembly to test a rupture disc. The method can include inserting the rupture disc between a disc holder and a clamp member to form a clamp subassembly. The method can further include aligning the clamp subassembly and a heater assembly with a gas port so that at least one heating element of the heater assembly extends into a central opening in a heater body of the heater assembly. The method can further include applying a clamping pressure to the clamp subassembly and the heater assembly. With an electronic controller, the heater assembly can be controlled to heat the rupture disc to a set temperature. The method can further include pressurizing the clamp subassembly and the heater assembly via the gas port until the rupture disc bursts at a burst pressure. The method can further include recording the burst pressure.

In some examples, a method for using a test assembly to test a rupture disc can include pressurizing a clamp subassembly and a heater assembly. Pressurizing the clamp subassembly can include, after an initial time interval of heating the rupture disc with the heater assembly, pressurizing the clamp subassembly and the heater assembly to a first pressure that is below a burst pressure of the rupture disc. After the clamp subassembly and the heater assembly are pressurized to the first pressure, the method can include heating the rupture disc with the heater assembly by heating the pressurized gas within the clamp subassembly and the heater assembly. After heating the pressurized gas within the clamp subassembly and the heater assembly, the method can further include pressurizing the clamp sub assembly and the heater assembly to the burst pressure.

In some examples, a method for using a test assembly to test a rupture disc can include pressurizing a clamp subassembly and a heater assembly to a burst pressure. This pressurization can include incrementally increasing pressurization of the clamp subassembly and the heater assembly, in combination with heating the pressurized gas with the heater assembly.

### BRIEF DESCRIPTION OF THE DRAWINGS

FIG. 1 shows a test assembly for testing a burst pressure of a rupture disc, according to an example of the disclosed technology.

FIG. 2 shows an example of a heater assembly of the test assembly of FIG. 1.

FIG. 3 shows an example of a gasket and the heater assembly of the test assembly of FIG. 1.

FIG. 4 shows an example of a thermocouple assembly of the test assembly of FIG. 1.

FIG. 5 shows an example of a disc holder of the test assembly of FIG. 1.

FIG. 6 shows an example rupture disc seated in the disc holder of FIG. 5.

FIG. 7 shows an example of a clamp subassembly of the test assembly of FIG. 1, the clamp subassembly including a clamp member and the disc holder of FIG. 5.

FIG. 8 shows an example of a vent member of the test assembly of FIG. 1.

FIG. 9 is a schematic illustration of a test system for testing a burst pressure of a rupture disc, according to an example of the disclosed technology.

FIG. 10 is a plan view of another example heater assembly of the test assembly of FIG. 1, according to an example of the disclosed technology.

FIG. 11 is an isometric view of an example of a heater body of the heater assembly of FIG. 10, according to an example of the disclosed technology.

FIG. 12 is a plan view of the heater body of FIG. 11.

FIG. 13 is an isometric view of another example of a heater body of a heater assembly, according to an example of the disclosed technology.

FIG. 14 is a plan view of the heater body of FIG. 13.

FIG. 15 is an isometric view of another example of a heater body of a heater assembly, according to an example of the disclosed technology.

FIG. 16 is a plan view of the heater body of FIG. 16.

FIG. 17 is a plan view of an example of a heater assembly with eight heating elements, according to an example of the disclosed technology.

FIG. 18 is a plan view of an example of a heater assembly with eight heating elements, according to another example of the disclosed technology.

FIG. 19 is a plan view of an example of a heater assembly with four heating elements, according to an example of the disclosed technology.

FIG. 20 is a plan view of an example of a heater assembly with four heating elements, according to another example of the disclosed technology.

FIG. 21 is a plan view of an example of a heater assembly with two heating elements, according to an example of the disclosed technology.

FIG. 22 is a plan view of an example of a heater assembly with one heating element, according to an example of the disclosed technology.

### DETAILED DESCRIPTION

The concepts disclosed in this discussion are described and illustrated with reference to exemplary arrangements. These concepts, however, are not limited in their application to the details of construction and the arrangement of components in the illustrative examples and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

The rupture disc test assemblies and methods disclosed herein may be embodied in many different forms. Accordingly, although several specific examples are discussed herein to exemplify principles of the disclosed technology, the disclosed technology is not intended to be limited to the examples illustrated.

As briefly described above, rupture discs may undergo rigorous testing to ensure that the discs meet certain qualification standards. For example, one or more sample rupture discs of a batch of rupture discs may be selected to undergo controlled rupture tests. These tests can certify that the rupture discs will not burst until at least a prescribed pressure level within a relevant fluid system, at a particular temperature. Conventional rupture tests can be resource intensive, and can accordingly take a long time to complete (e.g., over 7 hours). Conventional tests also demand high levels of energy consumption and require a large space to accommodate ovens and other test system components. Thus, throughput for particular test facilities may be correspondingly limited.

Some testing procedures include heating one or more sample discs to a set (test) temperature, and introducing pressurized gas onto one side of the disc (e.g., via nitrogen or hydrogen) until the sample discs burst. The temperature and pressure of the burst can then be recorded to certify (or not) the rated burst conditions of the rupture discs. Conventional methods for this type of testing of rupture discs can include baking one or more sample discs in an oven to a high temperature (e.g., 300 degrees Celsius) before pressurization, which can take relatively long amounts of time (e.g., 7 hours or more). This long test time, as well as other factors noted above, can delay production processes for entire batches of rupture discs, and create undesirably long lead times for delivery to customers.

Aspects of the present disclosure can address these and other drawbacks of conventional systems and methods for testing rupture discs. For example, some implementations of the present disclosure provide a test assembly having a rapid heater system that can heat rupture discs to a given test temperature (e.g., 300 degrees Celsius) in a considerably shorter time than conventional test ovens. For example, some test systems described herein can include a heater system that can heat a rupture disc to a test temperature in less than 5 minutes or, in some instances, less than 90 seconds. This rapid heating process can drastically decrease the test time and allow shipments of rupture discs to be certified and shipped to a customer in significantly faster than conventional methods.

Generally, test assemblies as disclosed herein can include a clamp subassembly that secures a rupture disc, and a heater assembly. The heater assembly in particular can include a heater body that supports one or more heating elements (e.g., high-output resistance heaters) with the heating element(s) extending into a central opening of the heater assembly. The heater assembly and the clamp subassembly can be aligned so that pressurized gas can be introduced into the central opening of the heater assembly both to be heated by the heating element(s) and to pressurize (one side of) the rupture disc. Correspondingly, the heating element(s) can be controlled to quickly heat the pressurized gas and the rupture disc to a desired (e.g., test) temperature. In this regard, for example, the heating element(s) can heat the rupture disc at least partly via convection of pressurized gas that moves across the heating element(s) within the central opening.

In some examples, corresponding methods for testing can be implemented. For example, a thermometer can be arranged to measure, directly or indirectly, a temperature of a rupture disc to be tested. As used herein, “thermometer” broadly indicates a sensor or other device configured to measure temperature, including thermocouples of various known designs. For example, in some configurations a thermocouple assembly can be arranged between a heater assembly and a rupture disc—or elsewhere within a test assembly—to sense the temperature of the heated pressurized gas to which the rupture disc is exposed. Thus, for example, electronic signals can be provided to a controller (e.g., a programmable industrial controller or general purpose electronic computer) that indicate whether the rupture disc has reached appropriate temperature for pressure testing. In response, the controller can then selectively (e.g., incrementally) increase pressure within the test assembly and selectively operate the heating element(s) so that the rupture disc and pressurized gas can be brought up to testing temperature, as needed, and the rupture disc can be pressurized to its rupture pressure.

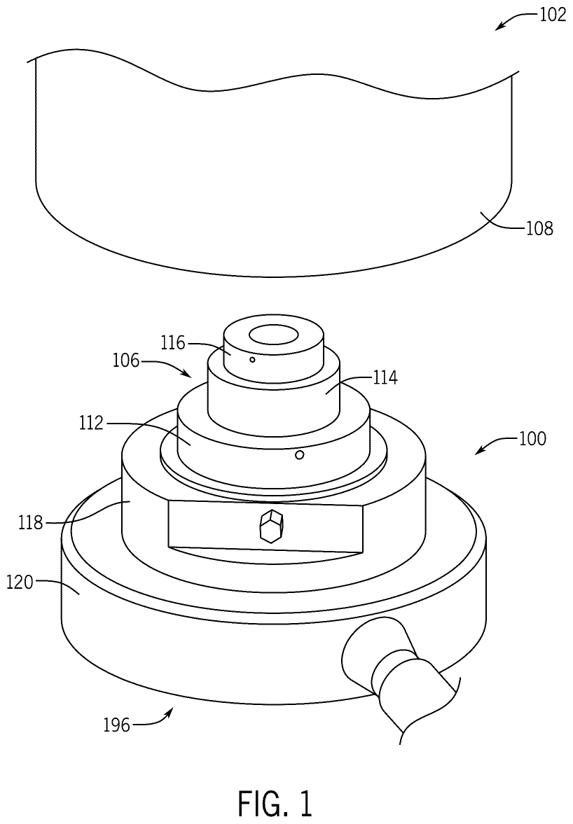

As one example, FIG. 1 illustrates a rupture disc test assembly 100 of a test system 102. In general, the test system 102 can be used to determine a burst pressure of a rupture disc at a given test temperature. The test assembly 100 includes a clamp subassembly 106 configured to receive a clamping force via a press 108 of the test system 102. Though not visible in FIG. 1, the clamp subassembly 106 retains a rupture disc 110 (see, e.g., FIG. 6) and generally constrains the rupture disc 110 in an axial direction and in a radial direction. The press 108 is configured to apply pressure to the rupture disc 110 via the clamp subassembly 106.

As shown in FIG. 1, the test system 102 can also include a vent member (or spacer) 116, a thermocouple assembly 118, and a heater assembly 120. The vent member 116 can be disposed, in the axial direction, between the clamp member 114 and the press 108. That is, the vent member 116 can be axially aligned with the clamp subassembly 106 and can transmit force from the press 108 to the clamp subassembly 106.

The heater assembly 120 can be disposed axially between the clamp subassembly 106 and a port (not shown in FIG. 1) arranged to deliver pressurized gas to the inside of the test assembly 100. Further, the thermocouple assembly 118 can be disposed, in the axial direction, between the clamp subassembly 106 and the heater assembly 120. Thus, as further discussed below, gas from the vent may pass across heating elements of the heater assembly 120 before reaching the thermocouple assembly 118 and the clamp subassembly 106.

In the example shown, each of the clamp subassembly 106, the vent member 116, the thermocouple assembly 118, and the heater assembly 120 have a generally circular outer profile (i.e., deviate from circular, relative to projected area by less than 15%) and are coaxially aligned with each other in the axial direction. However, in other examples, other geometries are possible for subassemblies to hold, clamp, heat, and monitor the rupture disc 110.

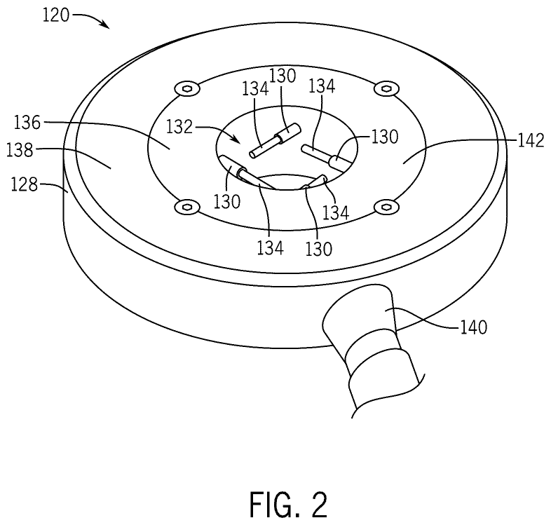

FIG. 2 shows the heater assembly 120 of the test assembly 100. The heater assembly 120 includes a heater body 128 and heating elements 130. Generally, the heater body 128 can surround a central opening for passage of pressurized gas during testing. For example, the heater body 128 as illustrated is configured as an annular ring with a central opening 132. In the illustrated example, the central opening 132 extends as a single opening, completely through the heater body 128 in the axial direction. However, in other examples, the heater body 128 may include a plurality of central openings or various other configurations (e.g., with passages oblique to the axial direction).

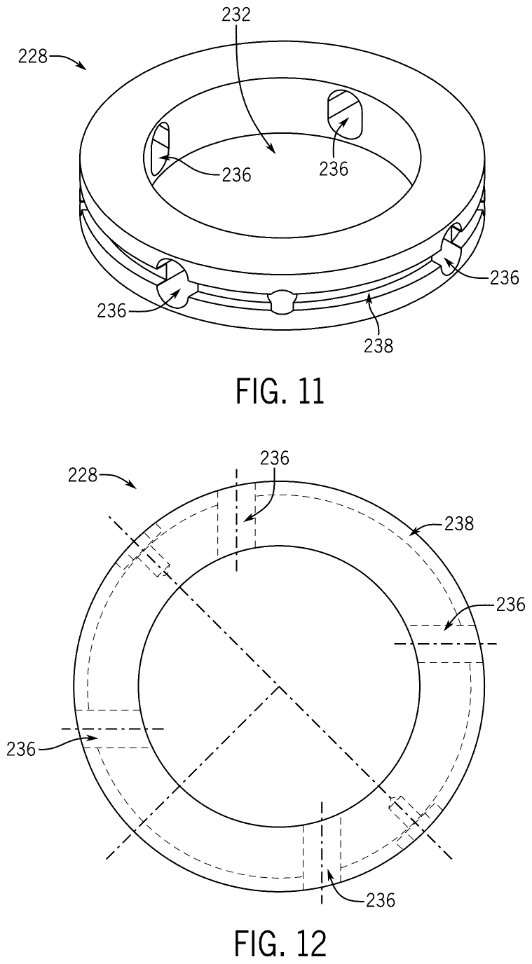

As shown in FIG. 2, the heating elements 130 can extend into the central opening 132 of the heater body 128. Accordingly, as pressurized gas passes through the central opening 132, the gas can be directly heated by the heating elements 130. In the illustrated example, the heating elements 130 extend through radial holes in the heater body 128 (see, for example, FIGS. 11-16), although other configurations are possible. Also as shown, bases of the heating elements 130 can be secured to the heater body 128 to be supported thereby (directly or indirectly) with heating ends 134 of the heating elements 130 disposed within the central opening 132.

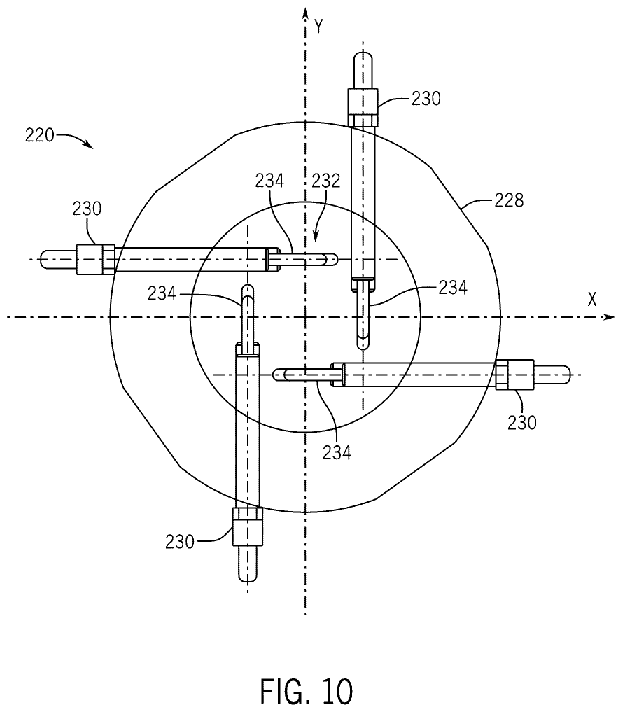

In FIG. 2, the heater body 128 is configured as an inner ring and is surrounded by an outer shroud 138. The inner ring can be secured to the outer shroud 138 via fasteners that secure the inner ring and the outer shroud 138 axially and rotationally. However, in other examples, the heater assembly 120 may not include an outer shroud. For example, the heater body 128 may include structures similar to the outer shroud 138 but be integrally formed as a single unitary body (see, for example, FIGS. 10-16).

In some examples, the heater assembly 120 can further include a connector 140 that connects the heater assembly 120 to a controller for power and control of the heating elements 130. For example, a wide variety of grommets or other wire guides can be used to contain and route wires or other signal lines from heating elements on the heater body 128 to an external controller.

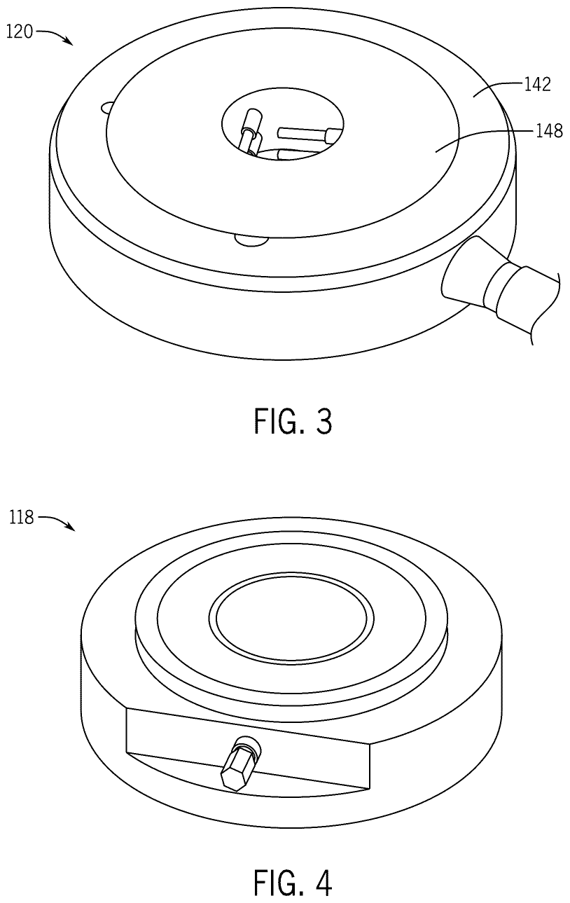

With reference to FIGS. 2 and 3, the heater body 128 can define a top surface 142 that is axially spaced from a bottom surface. As shown, the top surface 142 is planar, to provide a flat surface on which other parts of the test assembly 100 can be placed (i.e., stacked) and efficiently pressed. Thus, in some examples, the heater body 128 can define a pancake-like geometry.

As shown in FIG. 3, a gasket 148 can be placed on the top surface 142 of the heater body 128 to provide a gas seal for testing operations. The gasket 148, for example, can be a graphite gasket. However, other materials suitable for high temperatures (e.g., greater than 300 degrees Celsius) are possible. In general, the gasket 148 can provide a leak-free or leak-resistant seal between the heater assembly 120 and the thermocouple (e.g., in particular, relative to hydrogen or nitrogen gas). In other examples, similar or other gaskets can be arranged between other components of a test assembly, or may not be included at the heater body 128 or elsewhere.

FIG. 4 shows an example configuration of the thermocouple assembly 118. Generally, the thermocouple assembly 118 supports an electrical sensor that can measure temperature based on a developed voltage strength, and a wide variety of known thermocouple sensors can be used. Further, although the test assembly 100 of FIG. 1 includes the thermocouple assembly 118, other high temperature thermometers are possible.

In use, the thermocouple assembly 118 can measure temperature of the test assembly 100 to inform heating and pressurization operations. For example, the thermocouple 118 can measure temperature of the rupture disc 110 indirectly via measurement of the temperature of pressurized gas within the test assembly 100, or can be arranged to measure various other temperature data that may be indicative of rupture disc temperature (e.g., via contact with any of the various components discussed above).

Generally, temperature measurements from the thermocouple assembly 118 can be used as feedback signals for a controller to control the heater assembly 120. For example, prior to pressure testing, such a controller can use temperature signals from the thermocouple assembly 118 to selectively operate the heating elements 130 and thereby heat the rupture disc 110 to a given test temperature. Further, during pressure testing, the temperature measurements of the thermocouple assembly 118 can be used to monitor the real-time temperature of the rupture disc 110. For example, a controller may regulate increases in gas pressure within the test assembly 100 or may control operation of the heating elements 130, based on temperature measurements from the thermocouple assembly 118, to ensure that the rupture disc 110 is not over-pressurized before reaching a test temperature.

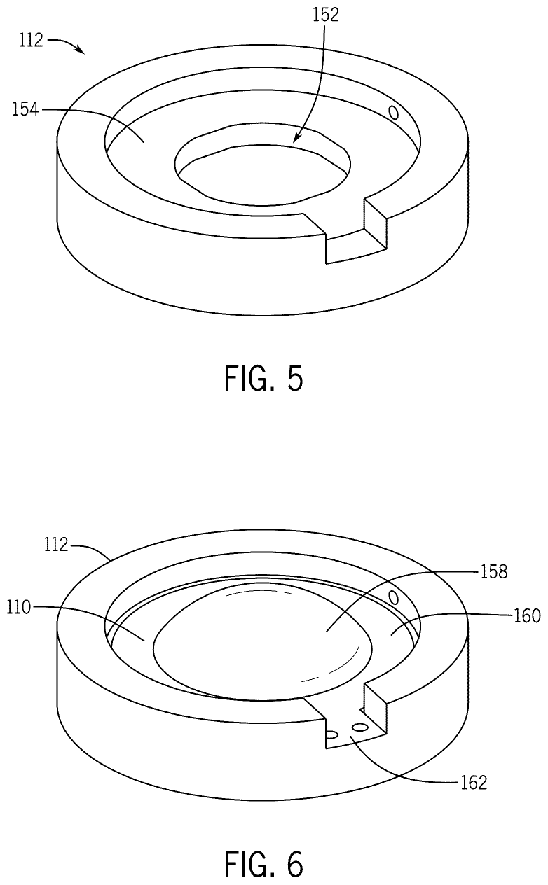

FIGS. 5 and 6 show an example configuration of the disc holder 112 of the test assembly 100. Generally, a disc holder can be configured to appropriately constrain a rupture disc so that the rupture disc can be clamped for pressure testing. In the illustrated example, in particular, the disc holder 112 includes a disc body that is configured as an annular ring having a central opening 152 and a receiving surface 154. As shown in FIG. 6, the rupture disc 110 can be seated on the receiving surface 154 of the disc holder 112. In the illustrated example, the receiving surface 154 of the disc holder 112 is a ledge that can constrain the rupture disc 110 in the axial direction relative to the disc holder 112. The rupture disc 110 includes a dome portion 158 and a circumferential or otherwise outer flange 160 that surrounds the dome portion 158. The circumferential flange 160 engages the receiving surface 154 of the disc holder 112 and the rupture disc 110 is rotationally constrained within the disc holder 112 via a tab of the circumferential flange 160 extending into a notch of the disc holder 112.

FIG. 7 illustrates the clamp subassembly 106 including the rupture disc 110 clamped between the disc holder 112 and the clamp member 114. The clamp member 114 generally defines a cylindrical body with a hole extending axially therethrough. The hole of the clamp member 114 provides a space for the dome portion 158 of the rupture disc 110 to extend into, and eventually during a testing process, burst into. The clamp member 114 clamps the circumferential flange 160 of the rupture disc 110 between the receiving surface 154 of the disc holder 112 and the clamp member 114. The clamp member 114 and the disc holder 112 can thus axially secure the rupture disc 110 within the test system 102. Furthermore, as shown in FIG. 1 in particular, the clamp subassembly 106 is configured to hold the rupture disc 110 adjacent to the heater assembly 120 so that the rupture disc 110 is in thermal communication with the heating elements 130

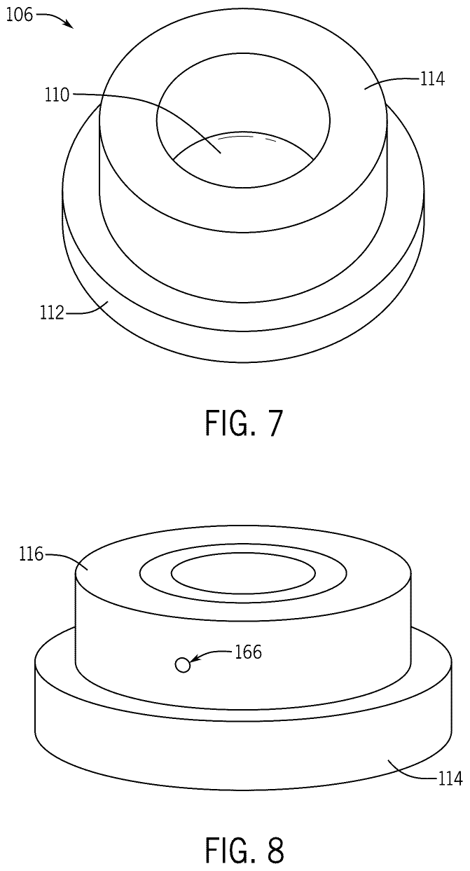

FIG. 8 illustrates the vent member 116 of the test assembly 100. The vent member 116 generally defines a cylindrical body with a hole extending axially therethrough, although other geometries are possible. The hole of the vent member 116 provides a pressure-reducing venting passageway that allows pressurized gas to vent out of the test assembly 100 once the dome portion 158 of the rupture disc 110 has burst during a testing procedure. In other examples, other known approaches can be used to vent pressure from a burst rupture disc.

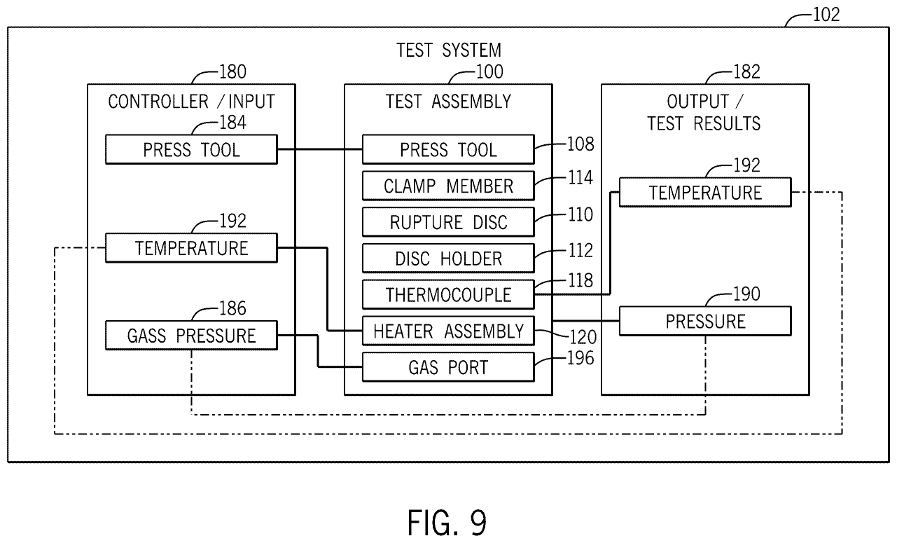

FIG. 9 schematically illustrates aspects a test system for rupture discs, including as can be implemented for the test system 102 of FIG. 1. In particular, the test system of FIG. 9 is described with reference to the test system 102 and the test assembly 100 described above. However, components in addition to or other than those described above may be used in test systems configured as in FIG. 9.

In the example of FIG. 9, the test system 102 includes the test assembly 100, a controller system 180, and an output system 182. The controller system 180 can provide inputs to control the test system 102. For example, the controller system 180 can control the position 184 of a ram of the press 108 to provide pressure to the clamp subassembly 106 and secure the test assembly 100 within a test area (e.g., a shielded area, but not an oven). The controller system 180 can also control a gas pressure 186 (e.g., nitrogen or hydrogen) within the clamp subassembly 106 and can control the heating elements 130 of the heater assembly 120 that heats the rupture disc 110 via a temperature controller 188. Generally, the controller system 180 can include one or more electronic controllers (e.g., a programmable industrial controller or general purpose electronic computer), which can be configured to receive and provide control signals for heating, pressurization, or other operations according to various approaches known in the art.

The output system 182 can provide outputs of the test system 102 that can be used for feedback to the controller system 180, real-time monitoring of the test assembly 100, or final test results of the test system 102. For example, outputs of the output system 182 can include a pressure output 190 and a temperature output 192. As also discussed above, the temperature output 192 can provide feedback to the controller 180 for control of the temperature 192 or pressure 186 during a heating process (e.g., when the heater assembly 120 is heating the rupture disc 110 to a set temperature for testing, or when flow of gas through a port 196 is being controlled to bring the rupture disc 110 to a set pressure for testing). Likewise, the temperature output 192 can allow real-time monitoring of the temperature of the rupture disc 110 during testing and a final temperature of the rupture disc 110 at a rupture event. Similarly, the pressure output 190 can provide feedback to the controller 180 for control of the gas pressure 186 (e.g., via control of flow through a port during pressurization), and for monitoring of a maximum gas pressure at the rupture event.

As generally described above, the test system 102 can be used to determine a burst pressure of a rupture disc during a rupture event. For example, a method of using the test assembly 100 of the test system can include assembling the clamp subassembly 106 by inserting the rupture disc 110 between the disc holder 112 and the clamp member 114. The clamp subassembly 106 can then be put in a test area with the thermocouple assembly 118 and the heater assembly 120. That is, the thermocouple assembly 118 can be stacked on top of the heater assembly 120, with the gasket 148 therebetween, and the clamp subassembly 106 can be stacked on top of the thermocouple assembly 118. The vent member 116 can be stacked on top of the clamp subassembly 106, according to an exemplary configuration. Further, each (or select) of the heater assembly 120, the thermocouple assembly 118, the clamp subassembly 106 with the rupture disc 110, and the vent member 116 can be axially aligned with the port 196, as shown in FIGS. 1 and 9.

The press 108 can then be controlled to apply pressure to the clamp subassembly 106. The pressure applied by the press 108 keeps the clamp subassembly 106 and other components in place during a test procedure. In particular, during a test procedure, pressurized gas is introduced into the clamp subassembly 106 and contained via force from the press 108 so that pressure is applied to the underside (i.e., concave side) of the dome portion 158 of the rupture disc 110. At sufficient pressures, the pressurized gas applies causes the dome portion 158 of the rupture disc 110 to burst, thereby releasing gas into the vent member 116. Ultimately, the test procedure can thus determine the burst pressure as the pressure of the pressurized gas at which the dome portion 158 bursts (e.g., opens, cracks, or otherwise allows gas to pass through).

During the test procedure, the controller 180 can maintain the rupture disc 110 at or near a set temperature by controlling the heater assembly 120 to heat the rupture disc 110 (e.g., indirectly, via heating of the pressurized gas). In particular, as also discussed above, the heater assembly 120 can bring the rupture disc 110 up to test temperature and can heat further incoming gas as pressure is increased. Once the rupture disc 110 reaches the set temperature, pressure can then be increased incrementally, with the rupture disc 110 remaining at a relatively steady temperature (e.g., +/−1 degree Celsius relative to the set temperature) until the dome portion 158 of the rupture disc 110 bursts and the test procedure is complete. In some test procedures, the set temperature may be approximately 300 degrees Celsius. In other test procedures, the set temperature may be between approximately 30 degrees Celsius and 400 degrees Celsius. In some embodiments, the test assembly 100 can provide a set temperature that is between 20 degrees Celsius and 400 degrees Celsius at increments of one degree Celsius.

The temperature controller 188 may signal for the heating elements 130 to cycle on and off during the heating period where the rupture disc is being heated to the set temperature. A pulsing voltage supplied to the heating elements can provide a controlled heating of the rupture disc 110. As described above, the thermocouple assembly 118 can sense the temperature of the rupture disc 110 and send feedback to the temperature controller 188 to provide precise and accurate heating signals to the heating elements 130.

It should be appreciated that steps of the method of using the test assembly 100 described above can occur in different orders, or in parallel. For example, the heater assembly 120 may first be placed in the test area and the controller system 180 may be used to begin heating the heating elements 130 before the clamp subassembly 106 is placed in the test area. Further, as also noted above, other particular components can be included (e.g., otherwise configured clamp subassemblies).

A particular testing procedure may be complete when the dome portion 158 of the rupture disc 110 bursts. At the end of the testing procedure, the output system 182 can provide metrics of the testing procedure, including data related to temperature and pressure of the rupture disc 110 during the testing procedure and at the time when the dome portion 158 ruptured. In an alternative example, the test system 102 may be used to determine a rupture temperature of a rupture disc at a set pressure, or independently vary temperature and pressure to determine rupture parameters or other characteristics of a rupture disc.

Advantages of the present disclosure provide rapid heating of a rupture disc in a rupture disc test assembly. As described above, traditional test assemblies can take hours (e.g., 7 or more hours) to bring the testing rupture disc to the set temperature (e.g., a set temperature of approximately 300 degree Celsius). In contrast, the rupture disc test assembly 100 described herein can heat a rupture disc to approximately 300 degrees within approximately 90 seconds. This drastically reduces the test procedure time compared to conventional methods and allows for rapid and high volume testing. Furthermore, advantages of the present disclosure provide rapid cooling of a test assembly. For example, embodiments of the invention can provide cooling from approximately 300 degrees Celsius down to approximately 100 degrees Celsius within approximately 20 seconds.

While the approximate times and temperatures described herein are by way of example, and can change depending on set temperature, heater assembly size, rupture disc size, and ambient conditions, it should be appreciated that examples of the inventive concept provide significantly faster testing procedures from start to finish compared to conventional heaters. That is, the test assembly described herein can complete a test procedure on the order of minutes (e.g., less than 10 minutes) compared to conventional test systems on the order of hours (e.g., more than 6 hours).

In general, the rapid heating of the rupture disc 110 is facilitated by the arrangement of the heater assembly 120 relative to the clamp subassembly 106 that holds the rupture disc 110. For example, the close proximity of the heater assembly 120 and the rupture disc 110 provides efficient convention, and in some instances, substantial radiative heating. Furthermore, the rapid heating of the rupture disc 110 can be facilitated by particular arrangements of the heating elements 130 in the heater body 128 of the heater assembly 120. For example, in some configurations the heating elements 130 extend (partly) radially inward within the central opening 132 of the heater body 128 to provide heat that rises to heat the adjacent dome portion 158 of the rupture disc 110.

In general, FIG. 2 illustrates one exemplary configuration of a heater assembly 120. However, other configurations are possible, including as shown in FIGS. 10-22. As described below, alternative geometries and heating element configurations can be used within a rupture disc test assembly, e.g., the test assembly 100, to achieve different heating times or set temperature, or to accommodate various rupture discs, which may vary in size, thickness, material, or test requirements.

FIG. 10 shows a heater assembly 220 according to another example of the disclosed technology. The heater assembly 220 includes a heater body 228 and heating elements 230. The heater body 228 includes a central opening 232 that extends through the heater body 228 in the axial direction. The heating elements 230 extend partly radially into the central opening 232 through holes formed in the heater body 228 (e.g., transversely to the axial direction, along non-diametric secants of the annular heater body 228, as shown). From a Cartesian perspective, each of the heating elements 230 opposite each other across the heater body 228 are offset in the respective x or y direction. For example, a central axis of each heating element 230 may extend generally parallel to one of the x or y-axes, but offset that axes in the x or y direction. In other embodiments, the heating elements 230 can extend into the central opening 232 and at an angle relative to the x and y axes. In general, this can efficiently arrange the heating ends 234 of the heating elements 230 across the area of the central opening 232 to provide efficient heating from the heater assembly 220.

FIGS. 11 and 12 illustrate the heater body 228 of the heater assembly 220. As shown, the heater body 228 includes holes 236 that extend partly radially through the heater body 228 and intersect with the central opening 232. The holes 236 can includes threads that engage corresponding threads of the heating elements 230. That is, the heating elements can include threads at their base ends (e.g., opposite the heating ends) that are threadedly received by the radial holes 236. Thus, during an assembly of the heater assembly 220, the heating elements 230 can be screwed into the heater body 228. Advantageously, this can allow for quick assembly, replacement, or reconfiguration of heater assemblies, and, furthermore, can facilitate the use of standardized heating elements, such as glow plugs (e.g., heating devices that may be used in engines or other systems).

Still referring to FIGS. 11 and 12, the heater body 228 can also include a circumferential groove 238. The circumferential groove 238 extends around an outer wall of the heater body 228 and intersects the holes 236. In one example, the circumferential groove 238 can be dimensioned to accommodate wires connected to the heating elements 230. Advantageously, the wired connection of the heating elements 230 of the heater assembly 220 (or other heater assemblies described herein) can provide individual and independent control of the heating elements 230. That is, for example, in some test procedures, a controller may only instruct two of the four heating elements 230 to heat up, or the controller may send different heating instructions to different heating elements 230.

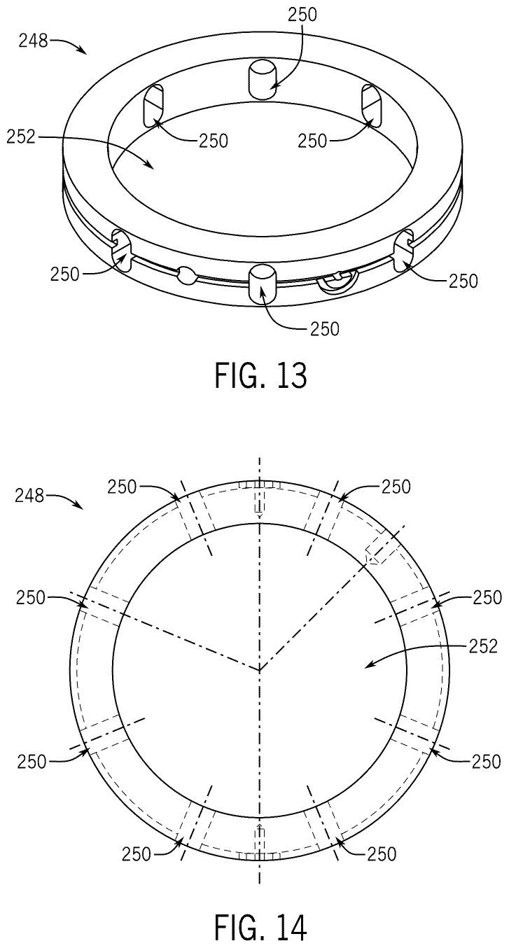

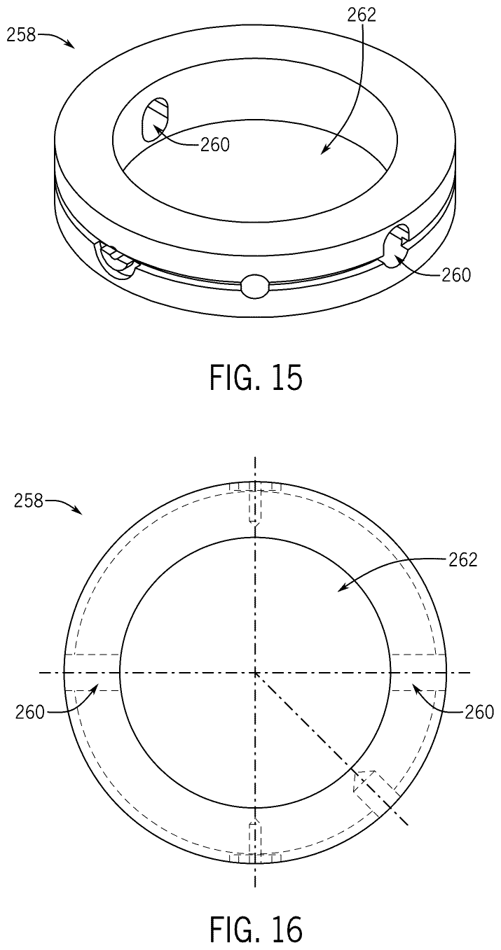

The configuration of the heating elements 230 as shown in FIG. 10 is presented by way of example, and other configurations are possible. For example, FIGS. 13 and 14 illustrate another heater body 248 having eight radial holes 250 that intersect with a central axial opening 252. The heater body 248 can threadedly accommodate eight heating elements 230 that extend radially through the holes 250 and into the central opening 252. Likewise FIGS. 15 and 16 show a heater body 258 having two radial holes 260 that intersect with a central axial opening 262.

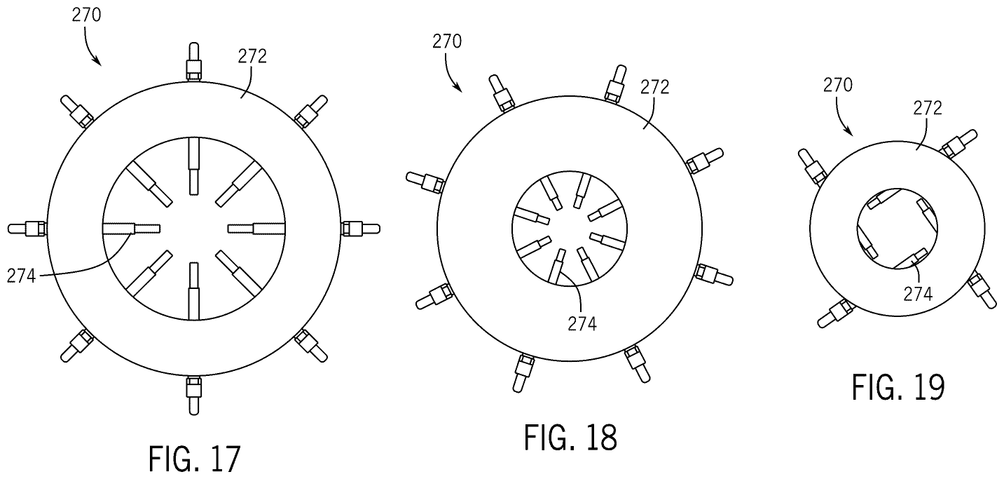

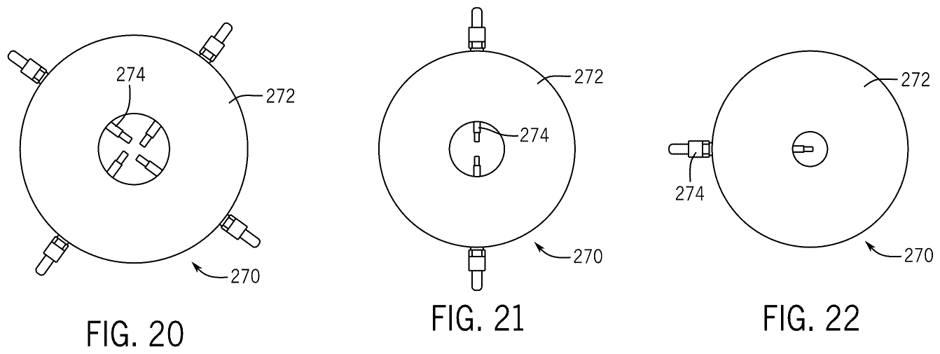

FIGS. 17-22 show additional examples of heater assemblies 270 with varying configurations of heater bodies 272 and heating elements 274. For example, FIGS. 17 and 18 show heater assemblies 270 with eight heating elements 274. The heater body 272 of FIG. 17 is narrower, in the radial direction, compared to the heater body 272 of FIG. 18. Varying the thickness (e.g., in the radial direction) of the heater body 272 can provide different heating properties of the heater assembly. FIGS. 19 and 20 show heater assemblies 270 with four heating elements 274 in different orientations and configurations. FIG. 21 shows a heater assembly 270 with dual heating elements 274 and FIG. 22 shows a heater assembly 270 with a single heating element. In general, different sizes and geometries of heater bodies 272 can be used to accommodate respective different sizes of rupture discs.

In other configurations, other numbers of heating elements other than those shown in FIGS. 17-22 can be used within a heater assembly. For example, in one configuration, twelve heating elements can be circumferentially spaced about a heater body to provide heat for a rupture disc test system. Still in other configurations, two or more heater assemblies may be independently controllable and arranged within a test system. For example, two or more heater assemblies may be arranged in series (e.g., stacked in an axial direction) to heat a rupture disc during a testing procedure.

Overall, rupture disc test assemblies according to examples of the disclosed technology can include a variety of geometries and configurations to accommodate a given testing procedure. For example, rupture discs come in a variety of sizes and specifications. Thus, appropriate test assemblies can be selected, including test assemblies and heater assemblies described herein and variations thereof. An appropriate test assembly can accommodate testing requirements of a given rupture disc, including accommodating the size of the rupture disc, expected test pressures, and heating requirements (e.g., temperature and heating duration). In general, the rupture disc test assembly systems described herein provide faster and more efficient testing procedures compared to conventional setups, which can take hours to complete, causing undesirable lead times and energy consumption.

Thus, examples of the disclosed technology can provide an improvement over conventional systems and methods for testing and certifying rupture discs and their rated burst temperature and pressure. The previous description of the disclosed examples is provided to enable any person skilled in the art to make or use the disclosed technology. Various modifications to these examples will be readily apparent to those skilled in the art, and the generic principles defined herein may be applied to other examples without departing from the spirit or scope of the disclosed technology. Thus, the disclosed technology is not intended to be limited to the examples shown herein but is to be accorded the widest scope consistent with the principles and novel features disclosed herein

Unless otherwise specified or limited, the terms “about” and “approximately,” as used herein with respect to a reference value, refer to variations from the reference value of ±15% or less, inclusive of the endpoints of the range. Similarly, the term “substantially,” as used herein with respect to a reference value, refers to variations from the reference value of ±5% or less, inclusive of the endpoints of the range.

Also as used herein with respect to clamped systems, unless otherwise specified or limited, “axial” is used to refer to a clamping direction and “radial” is used to refer to directions that are perpendicular to the clamping direction. Thus, for example, in a system applying a vertical clamp force to hold together a heater assembly and a clamp subassembly, an axial direction is parallel to the vertical direction and radial directions are parallel to horizontal.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

In some examples, aspects of the disclosed technology, including computerized implementations of methods according to the disclosed technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, configurations of the disclosed technology can be implemented as a set of instructions, tangibly embodied on a non-transitory computer-readable media, such that a processor device can implement the instructions based upon reading the instructions from the computer-readable media. Some examples of the disclosed technology can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some examples, a control device can include a centralized hub controller that receives, processes and (re)transmits control signals and other data to and from other distributed control devices (e.g., an engine controller, an implement controller, a drive controller, etc.), including as part of a hub-and-spoke architecture or otherwise.

Certain operations of methods according to the invention, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular examples of the invention. Further, in some examples, certain operations can be executed in parallel, including by dedicated parallel processing devices, or separate computing devices configured to interoperate as part of a large system.

In some implementations, devices or systems disclosed herein can be utilized, manufactured, installed, etc. using methods embodying aspects of the disclosed technology. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as examples of the disclosed technology, of the utilized features and implemented capabilities of such device or system.

Also as used herein, unless otherwise defined or limited, directional terms are used for convenience of reference for discussion of particular figures or examples or to indicate spatial relationships relative to particular other components or context, but are not intended to indicate absolute orientation. For example, references to downward, forward, or other directions, or to top, rear, or other positions (or features) may be used to discuss aspects of a particular example or figure, but do not necessarily require similar orientation or geometry in all installations or configurations.

Also as used herein, unless otherwise limited or defined, “configured to” indicates that a component, system, or module is particularly adapted for the associated functionality. Thus, for example, a ZZ configured to YY is specifically adapted to YY, as opposed to merely being generally capable of doing so.

Although the presently disclosed technology has been described with reference to preferred examples, workers skilled in the art will recognize that changes may be made in form and detail to the disclosed examples without departing from the spirit and scope of the concepts discussed herein.

1. A test assembly for a rupture disc, the test assembly comprising:
a disc holder arranged to hold the rupture disc;
a clamp member arranged opposite the rupture disc from the disc holder to clamp the rupture disc between the disc holder and the clamp member, to constrain the rupture disc in an axial direction; and
a heater assembly in thermal communication with the disc holder, the heater assembly including:
a heater body having an opening and at least one hole, the opening being axially aligned with disc holder so as to be axially aligned with the rupture disc as clamped between the disc holder and the clamp member, and the at least one hole extending through the heater body and intersecting the opening; and
at least one heating element extending through the at least one hole and projecting into the opening.

2. The test assembly of claim 1, wherein the at least one heating element is threadedly received by the at least one hole of the heater body.

3. The test assembly of claim 1, wherein the at least one heating element includes a glow plug.

4. The test assembly of claim 1, wherein the heater body includes an annular ring, the opening is a central opening of the annular ring, and the at least one hole extends partly radially through the annular ring.

5. The test assembly of claim 4, wherein the heater body includes a circumferential groove that receives one or more wires that power the at least one heating element.

6. The test assembly of claim 1, wherein the at least one hole includes a plurality of holes and the at least one heating element includes a plurality of heating elements, each heating element of the plurality of heating elements extending into the opening through a respective hole of the plurality of holes.

7. The test assembly of claim 1, wherein the heater assembly is a first heater assembly, and the test assembly further comprises a second heater assembly,
the first and second heater assemblies arranged in series to heat the rupture disc.

8. The test assembly of claim 1, further comprising:
a thermometer arranged to output signals indicating temperature at the rupture disc during a test; and
an electronic control device configured to control pressurization of gas against the rupture disc based on the output signals from the thermometer.

9. The test assembly of claim 8, wherein the thermometer includes a thermocouple assembly that is disposed, in the axial direction, between the disc holder and the heater assembly.

10. The test assembly of claim 9, further comprising a gasket that is disposed, in the axial direction, between the heater assembly and the thermocouple assembly, to provide a gas seal between the heater assembly and the thermometer.

11. The test assembly of claim 1, wherein an arrangement of the at least one heating element within the heater assembly is configured to heat the rupture disc to a set temperature between 100 degrees Celsius and 400 degrees Celsius, inclusive, in less than 5 minutes.

12. A test assembly for rupture discs, the test assembly comprising:
a heater body having a central opening configured to be axially aligned with a rupture disc being tested, so that pressurized gas within the central opening is in communication with the rupture disc; and
at least one heating element extending into the central opening and supported by the heater body so that the at least one heating element is spaced axially apart from the rupture disc to heat the rupture disc via convection of the pressurized gas.

13. The test assembly of claim 12, further comprising:
an electronic controller configured to receive a temperature signal from a thermocouple in thermal communication with the pressurized gas and to control the heat supplied by the at least one heating element based on the temperature signal and a test-procedure set temperature.

14. The test assembly of claim 13, wherein the heater body includes a circumferential groove that receives one or more wires to connect the controller and the at least one heating element.

15. The test assembly of claim 12, wherein the heater body surrounds the central opening; and
wherein the at least one heating element is secured relative to the heater body via a threaded connection within a corresponding at least one hole that extends through the heater body and intersects the central opening.

16. The test assembly of claim 14, wherein the heater body includes an annular ring that defines a planar top surface that is axially spaced from a bottom surface.

17. The test assembly of claim 12, wherein the heater body is an integrally formed, unitary body.

18. A method of using a test assembly to test a rupture disc, the method comprising:
inserting the rupture disc between a disc holder and a clamp member to form a clamp subassembly;
aligning the clamp subassembly and a heater assembly with a gas port so that at least one heating element of the heater assembly extends into a central opening in a heater body of the heater assembly;
applying a clamping pressure to the clamp subassembly and the heater assembly;
with an electronic controller, controlling the heater assembly to heat the rupture disc to a set temperature;
pressurizing the clamp subassembly and the heater assembly via the gas port until the rupture disc bursts at a burst pressure; and
recording the burst pressure.

19. The method of claim 18, wherein pressurizing the clamp subassembly and the heater assembly includes:
after an initial time interval of heating the rupture disc with the heater assembly, pressurizing the clamp subassembly and the heater assembly to a first pressure that is below the burst pressure;
after the clamp subassembly and the heater assembly are pressurized to the first pressure, heating the rupture disc with the heater assembly by heating the pressurized gas within the clamp subassembly and the heater assembly; and
after heating the pressurized gas within the clamp subassembly and the heater assembly, pressurizing the clamp subassembly and the heater assembly to the burst pressure.

20. The method of claim 19, wherein pressurizing the clamp subassembly and the heater assembly to the burst pressure includes incrementally increasing pressurization of the clamp subassembly and the heater assembly, in combination with further heating of the pressurized gas with the heater assembly.
